(19) United States
(12) Patent Application Publication
(10) Pub. No.: US 2010/0203343 A1
(43) Pub. Date: Aug. 12, 2010

(54) ANTIRUST TREATED METAL

(75) Inventors: Yu Takada, Toyota-shi (JP); Noriyuki Kuramoto, Yonezawa-shi (JP)

Correspondence Address: KENYON & KENYON LLP, 1500 K STREET N.W., SUITE 700, WASHINGTON, DC, 20005, US

(73) Assignee: TOYOTA JIDOSHA KABUSHIKI KAISHA, Toyota-shi (JP)

(21) Appl. No.: 12/679,786

(22) PCT Filed: Sep. 23, 2008
(86) PCT No.: PCT/IB08/02469

§ 371 Date: Mar. 24, 2010

(30) Foreign Application Priority Data
Sep. 25, 2007 (JP) 2007-247189

(51) Int. Cl. B32B 15/08; B32B 15/082; B32B 15/092; B32B 15/09; B32B 15/095

(52) U.S. Cl. 428/418; 428/457; 428/461; 428/463; 428/425.8; 428/458; 428/447

(57) ABSTRACT

In an antirust treated metal base material in accordance with the present invention, a coating film containing insulating polyaniline in a highly oxidized state (PE state) is formed on the surface of a metal base material. A method for antirust treatment of the surface of a metal base material includes a process of forming a coating film containing insulating polyaniline in a highly oxidized state (PE state) on the metal base material surface. According to the present invention, an antirust treated metal base material, in which the coating film of an insulating polyaniline system containing no dopants exhibits strong corrosion inhibition effect, and a method of antirust treatment for the metal base material are provided.

### BACKGROUND OF THE INVENTION

1. Field of the Invention

The present invention relates to an antirust treated metal base material and a method for antirust treatment of a metal base material surface, and more particularly to an antirust treated metal base material having a high corrosion inhibition effect (can be also referred to hereinbelow as “antirust effect”) on the surface of a metal base material such as iron sheet, and to a method for antirust treatment of a metal base material surface.

2. Description of the Related Art

An antirust treated metal base materials, in which the metal surface is subjected to an antirust treatment, and methods for antirust treatment of surfaces of various metal base materials are available. One example is a technology for antirust treatment of a metal surface by forming a polymer film including a polyaniline on the metal surface, and further attempts to improve polyaniline-type polymer films formed on the metal surface have been attempted.

Japanese Patent No. 3129837 describes that a metal material demonstrates an excellent antirust effect in a corrosive environment such as table salt by forming a coating film including an electrically conductive polymer such as a soluble polyaniline and optionally also a polymer compound of general use on the metal surface. The document discloses that the polyaniline is electrically activated by a dopant and demonstrates the anticorrosive effect.

Japanese Patent No. 3129838 also describes that the formation of a film of a soluble polyaniline compound containing no dopant on a metal surface prevents the corrosion caused by the dopant and enables the metal material to demonstrate excellent antirust effect even under a strongly corrosive environment. Further, in a specific example described in the document, a polyaniline solution is heated and dried for 1 h at 130° C. on an iron sheet to form a polyaniline film of deep blue color, and the antirust effect is determined by visually observing whether or not rust has occurred on the iron sheet surface.

Japanese Patent No. 3233639 describes that corrosion resistance is imparted to a metal surface by a method for manufacturing a laminated body by which a metal is coated with a composite of a true conductive polymer such as a polyaniline and a nonconductive matrix. This document also indicates that leucomeraldine in a reduced state, emeraldine in a partially oxidized state, and pernigraniline in a completely oxidized state are present in the polyaniline and describes a polyaniline doped with a dopant such as p-toluenesulfonic acid as a truly conductive polymer.

Japanese Patent Application Publication No. 10-251509 (JP-A-10-251509) describes a water-soluble and/or water-dispersible treatment liquid for a metal surface that has a mixture of a resin, a polyaniline and/or a polyaniline derivative, and an inorganic compound as a main component and also that surface-treated sheets of various metals having a film using this surface treatment liquid demonstrate corrosion resistance and adhesion. The polyaniline used is generally in a state in which it is partially oxidized (emeraldine) and is a compound that has two N atoms in a molecule, one being coupled to a H atom and the other being not coupled to the H atom. The coating film indicated in the specific example is described to be obtained by coating a treatment liquid including a resin composition containing the polyaniline and a resin as the main component and heating and drying the coating film at 150° C. The anticorrosive effect is determined by visually observing whether or not rust has occurred on the metal sheet surface.

Thus, examples are known in which a variety of improvements relating to corrosion inhibition with polyaniline films on a metal base material under a corrosive environment resulted in the utilization of an electrically conductive polyaniline doped with a dopant or a soluble polyaniline that contains no dopant. However, in the methods for antirust treatment of metals with electrically conductive polyaniline films doped with a dopant of the related art, corrosion caused by the dopant cannot be avoided. In the methods for antirust treatment of metals with a soluble polyaniline film containing no dopant of the related art, no relationship is recognized between the oxidation state of polyaniline and the corrosion inhibition effect. Further, in the related art, the antirust effect is evaluated by visual observations, and the degree of the antirust effect of the coating film formed and also whether the antirust effect is achieved when the type of the coating film and conditions of coating film formation are changed are unclear.

### SUMMARY OF THE INVENTION

The present invention provides an antirust treated metal base material and a method for antirust treatment of a metal base material surface in which a strong corrosion inhibition effect is demonstrated by a coating film of an insulating polyaniline system containing no dopant.

In the antirust treated metal base material according to the first aspect of the present invention, a coating film containing an insulating polyaniline in a highly oxidized state (PE state) is formed on a metal base material surface.

Further, in the antirust treated metal base material according to the first aspect, the metal base material is one from among an iron sheet, a zinc-plated steel sheet, an aluminum-plated steel sheet, a magnesium-plated steel sheet, an aluminum sheet, and a magnesium sheet.

The metal base material surface may be passivated with a polyaniline.

The coating film containing an insulating polyaniline in a highly oxidized state (PE state) may be formed on the metal base material surface by applying a coating liquid containing an insulating polyaniline in a highly oxidized state (PE state) to the metal base material surface.

The coating liquid may contain at least one resin from among a thermoplastic resin, a thermosetting resin, a resin curable at normal temperature, and a synthetic rubber, and a ratio of the insulating polyaniline in a highly oxidized state (PE state) to the resin may be equal to or higher than 0.2 wt. %.

The ratio of the insulating polyaniline in a highly oxidized state (PE state) to the resin may be equal to or higher than 1 wt. %.

The resin may contain at least one from among an acrylic resin, an epoxy resin, an epoxy-phenolic resin, an unsaturated polyester, a polyurethane resin, a block urethane resin, a two-component polyurethane resin, a phenolic resin, an alkyd resin, an epoxy alkyd resin, a polyimide, and a silicone resin.

The coating film containing an insulating polyaniline in a highly oxidized state (PE state) may be formed on the metal base material surface by applying a coating liquid containing an insulating polyaniline in a partially oxidized state (EB state) on the metal base material surface and oxidizing the polyaniline in the EB state at a temperature equal to or higher than 150° C. and lower than 200° C. in the presence of an oxidizing agent.

The coating film containing an insulating polyaniline in a highly oxidized state (PE state) may be formed on the metal base material surface by oxidizing the polyaniline in a partially oxidized state (EB state) at a temperature equal to or higher than 170° C. and lower than 200° C. in the presence of an oxidizing agent.

The weight-average molecular weight (M_{W}) of the polyaniline in the highly oxidized state (PE state) may be equal to or higher than 10,000.

The weight-average molecular weight (M_{W}) of the polyaniline in the highly oxidized state (PE state) may be 20,000 to 120,000.

The weight-average molecular weight (M_{W}) of the polyaniline in the highly oxidized state (PE state) may be 40,000 to 100,000.

According to the first aspect of the present invention, an antirust treated metal base material is obtained in which corrosion caused by a dopant can be prevented and good corrosion inhibition is demonstrated.

A method for antirust treatment of a metal base material surface according to the second aspect of the present invention includes a process of forming a coating film containing an insulating polyaniline in a highly oxidized state (PE state) on the metal base material surface.

The polyaniline may be in a highly oxidized state (PE state) before the coating film is formed.

According to the second aspect of the present invention, an antirust treated metal base material having good ability to inhibit corrosion can be provided by a simple method.

### BRIEF DESCRIPTION OF THE DRAWINGS

The foregoing and further features and advantages of the invention will become apparent from the following description of example embodiments with reference to the accompanying drawings, where the like numerals are used to represent like elements, and wherein:

FIG. 1 illustrates cyclic voltammetry (CV) of a coated steel sheet that is coated with a polyaniline in a PE state in accordance with the present invention; and

FIG. 2 illustrates CV of a coated steel sheet that is coated with a polyaniline in an EB state.

### DETAILED DESCRIPTION OF EMBODIMENTS

Embodiments of the present invention are described below. (1) An antirust treated metal base material in which the metal base material is one from among an iron sheet, a zinc-plated steel sheet, an aluminum-plated steel sheet, a magnesium-plated steel sheet, an aluminum sheet, and a magnesium sheet. (2) The antirust treated metal base material in which the metal base material is passivated with a polyaniline. (3) The antirust treatment method in which the polyaniline is in a highly oxidized state (PE state) before the coating film is formed.

In the present embodiment, the insulating polyaniline in a highly oxidized state (indicates the completely oxidized state) (such polyaniline can be referred to hereinbelow simply as polyaniline in a PE state) is a polyaniline in a completely oxidized state represented by a General Formula (1) below and means a state in which it can be used, without the co-presence of a dopant, in a coating film. The polyaniline in a PE state has a deep violet color or black violet color.

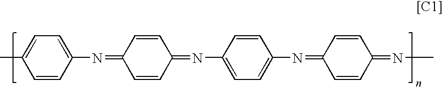

(wherein, n stands for integer).

On the other hand, a polyaniline in a partially oxidized state (EB state) (such polyaniline can be referred to hereinbelow simply as polyaniline in an EB state) is a polyaniline represented by a General Formula (2) below. The polyaniline in the EB state has a deep blue color.

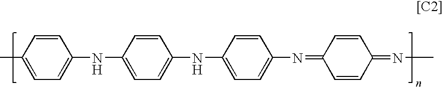

(wherein, n stands for integer).

The polyaniline in a PE state of the present embodiment can be obtained by heating the polyaniline in an EB state in the presence of an oxidizing agent, for example in the air, at a temperature equal to or higher than 150° C. and lower than 200° C., preferably at a temperature equal to or higher than 170° C. and lower than 200° C., till the oxidation is completed and a completely oxidized state is assumed. The heating is carried out preferably for 45 min to 3 h. The heating temperature equal to or higher than 200° C. is undesirable because the polyaniline starts decomposing. Further, a polyaniline in a PE state is difficult to obtain by heating the polyaniline in an EB state in the air at a temperature below 150° C. Further, the heating time may be longer at a lower heating temperature and shorter at a higher heating temperature, and the heating temperature may be appropriately selected within the above-described range.

The polyaniline in a PE state in the present embodiment is preferably obtained by heating the polyaniline in an EB state with a weight-average molecular weight (M_{W}) equal to or higher than 10,000, preferably 20,000 to 120,000, in particular 40,000 to 100,000 in the presence of an oxidizing agent, for example in the air, under the above-described heating conditions.

The polyaniline in an EB state that is used for obtaining the polyaniline in a PE state can be easily obtained, for example, by gradually adding a polymerization initiator, for example ammonium persulfate, to an aqueous solution containing an aniline monomer, for example aniline or aniline hydrochloride, in a concentration of about 0.5 to 5 mol/L as a starting material in a total amount of the polymerization initiator of about 1.1 to 1.5 molar ratio to the aniline monomer, performing oxidation polymerization, adding acetone and methanol to the reaction liquid obtained in order to precipitate a polyaniline, collecting the precipitated polyaniline by filtration (filtering, washing), and drying.

In the present embodiment, the insulating polyaniline in a PE state has to be contained in the coating film. As a result, it is possible to obtain a coating film having a high antirust effect with good reproducibility, regardless of the coating film formation conditions.

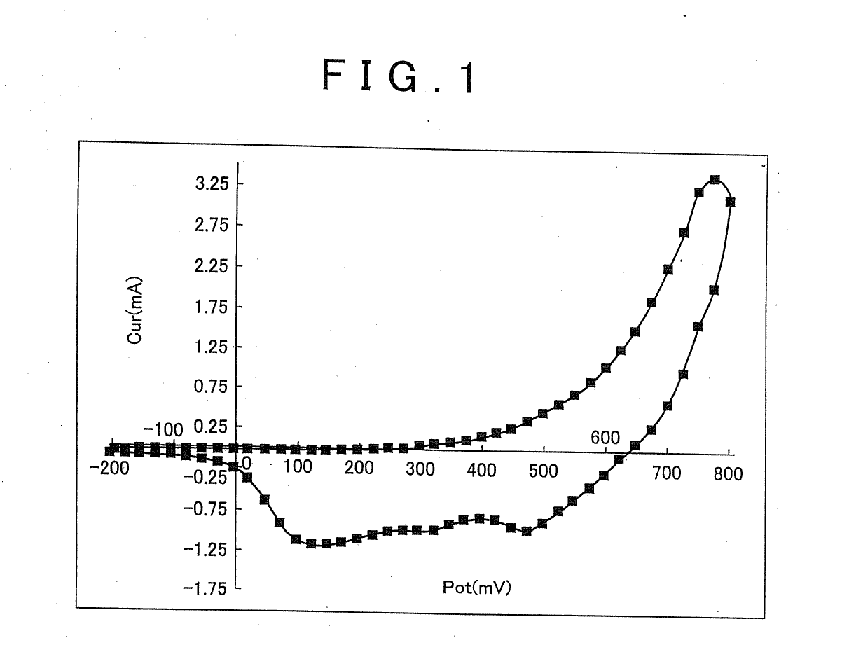

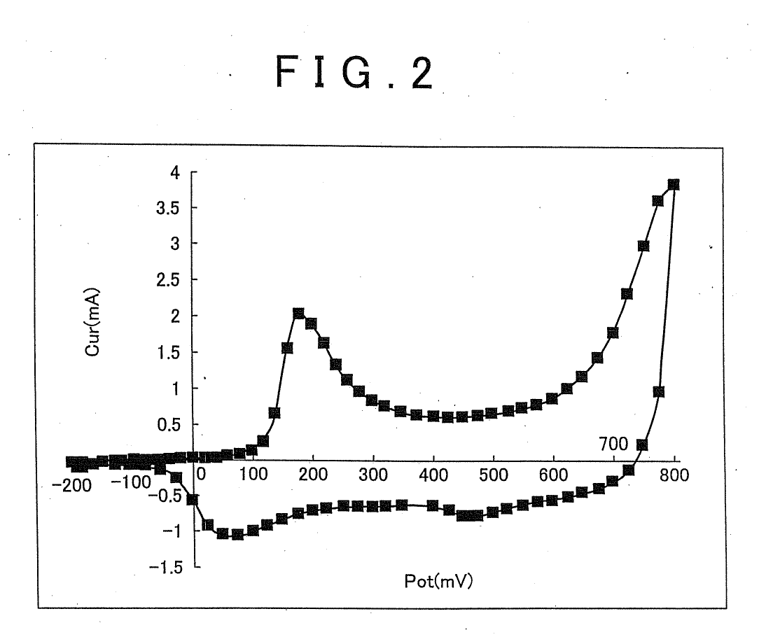

The polyaniline in a PE state and the polyaniline in an EB state of the present embodiment will be explained below with reference to FIGS. 1 and 2 that show CV of steel sheets coated with the polyanilines of these two types. In FIG. 1, a curve representing one cycle of the steel sheet coated with the polyaniline in a PE state is smooth, whereas a curve representing one cycle of a steel sheet coated with polyaniline in an EB state that is shown in FIG. 2 has a significant peak at about 200 to 250 mV.

In the present embodiment, the metal base material is a sheet or thin sheet including iron or a metal that is less noble than iron, for example, an iron sheet, a zinc-plated steel sheet, an aluminum-plated steel sheet, a magnesium-plated steel sheet, an aluminum sheet, or a magnesium sheet. The shape of the metal base material is not particularly limited and the material may have any shape. For example, the material may have a flat or curved surface, for example, a cylindrical shape. Before coating with a coating liquid, the base metal material may be subjected to washing of any kind or treatment for adhesion improvement in order to improve the adhesion with a coating film immediately before the coating liquid is coated.

The antirust treated metal base material of the present embodiment can be obtained by forming a coating film by any method by using the polyaniline in a PE state and without using a dopant that imparts electric conductivity. For example, the antirust treated metal base material can be obtained using a first method that coats a coating liquid that is a solvent solution including only a polyaniline that has been converted into a PE state in advance or a resin composition of a polyaniline converted into a PE state and another resin on the metal base material surface and then dries and forms a coating film including an insulating polyaniline in a PE state on the metal base material surface.

Alternatively, the antirust treated metal base material of the present embodiment can be obtained using a second method that coats a coating liquid that is a solvent solution of the polyaniline in an EB state on the metal base material surface, or immerses the metal base material surface into the coating liquid, then heats and dries in the presence of an oxidizing agent, for example in the air, preferably for 45 min to 3 h, at a temperature equal to or higher than 150° C. and lower than 200° C. till the oxidation of the polyaniline in an EB state is completed and a polyaniline in a completely oxidized state (PE state) is obtained, and forms a coating film of an insulating polyaniline in a PE state on the metal base material surface.

In the aforementioned second method, when a coating liquid of a resin mixture including another resin as a main component and a polyaniline in an EB state is coated on the metal base material surface, the condition of the presence of an oxidizing agent is not met and a coating film having a high antirust effect is difficult to obtain even when heating after the coating is performed under the heating conditions specified by the aforementioned temperature and time. In the second method, after the coating film of an insulating polyaniline in a PE state has been formed on the metal base material surface, a resin coating film may be formed thereupon.

Examples of the solvent for the coating liquid include nitriles such as acetonitrile, polar solvents such as N-methylpyrrolidone, dimethylformamide, dimethylsulfoxide, and m-cresol, aromatic hydrocarbons such as toluene and xylene, and halogenated hydrocarbons such as chloroform.

With all the above-described methods, in the antirust treated metal base material in which a coating film of a polyaniline in a PE state is formed on the metal base material surface, because the metal surface is passivated by the polyaniline in a PE state, the adhesion force between the metal base material and coating film, and the corrosion potential are further increased, and a good antirust effect is demonstrated compared to the case provided with the passivation with a polyaniline in an EB state. Other resins may be mixed with the polyaniline in a PE state as long as the passivation is not impeded.

For example, when a resin mixture of a polyaniline and another resin is used in the above-described first method, the content ratio of polyaniline may be equal to or higher than 0.2 wt. %, especially equal to or higher than 1 wt. % based on the other resin. The type of the other resin is not particularly limited. Examples of suitable other resins include a thermoplastic resin, a thermosetting resin, a resin curable at normal temperature, and a synthetic rubber.

The aforementioned resin may be an acrylic resin, an epoxy resin, an epoxy-phenolic resin, an unsaturated polyester, urethane resins such as a polyurethane resin and a block urethane resin and a two-component polyurethane resin, a phenolic resin, an alkyd resin, an epoxy alkyd resin, a polyimide, and a silicone resin. Where a curable resin of a two-liquid type that is curable at normal temperature (also referred to as “two-liquid resin for drying at normal temperature”) is selected from among the aforementioned resins, a strong bonding force can be obtained.

An antirust pigment may be added to the above-described components in the coating liquid. Examples of the antirust pigment include a phosphate antirust pigment such as zinc phosphate and aluminum phosphate antirust pigments, a phosphate antirust pigment, and a molybdate antirust pigment. The amount of the antirust pigment added can be appropriately selected according to the type and application of the metal base material.

When it is necessary to obtain stronger bonding between a metal surface and a coating film and increase adhesivity, a coupling agent such as a silane coupling agent and a titanium coupling agent may be added to other aforementioned components in the coating liquid. Methoxy, ethoxy, acetoxy, and amino coupling agents can be advantageously used as the coupling agent.

A method for coating the coating liquid on the metal base material surface in all the above-described methods is not particularly limited, and coating with a roll coater, a ringer roller, a sprayer, or a bar coater, or coating by dipping or by air knife squeezing can be employed.

An antirust treated metal base material can be obtained using the above-described first method that coats the coating liquid on a metal base material surface, then dries, and forms a coating film including an insulating polyaniline in a PE state on the metal base material surface. The thickness of the coating film including an insulating polyaniline in a PE state in the present embodiment is not particularly limited, and the dry film thickness may be equal to or larger than 0.01 μm and equal to or smaller than 100 μm. Where the coating film thickness is too small, the antirust effect is small, and where the coating film thickness is too large, the process is cost inefficient, while no significant improvement in antirust ability is achieved.

With the antirust treated metal base material and antirust treatment method using a polyaniline that has been converted into a PE state in advance by the first method of the present embodiment, the antirust treated metal base material having a coating film demonstrating a high antirust effect with good reproducibility can be obtained by drying the metal base material at a temperature equal to or lower than about 50° C., that is, without heating at a high temperature. Therefore, the antirust treated metal base material and antirust treatment method are suitable for applications to metal base materials that can be deformed by heating, such as thin steel sheets.

The antirust treated metal base material obtained in accordance with the present invention can be used for a variety of metal sheets requiring antirust treatment that are used in automobiles, trains, and construction industry.

The present invention will be described below in greater details based on examples thereof, but the present invention is not limited to these examples. In the examples below, the evaluation of polyaniline properties and evaluation of antirust treated steel sheets was performed by the following methods.

(1) CV of polyaniline-Coated Steel Sheet.

CV was performed with respect to a polyaniline-coated steel sheet by the following method. A platinum sheet was immersed into a polyaniline solution (5 wt. % N-methyl-2-pyrrolidone solution), pulled out, and dried at room temperature. The platinum sheet coated with the polyaniline was used as a work electrode, and a platinum sheet was used as a counter electrode, an electric potential was changed from −200 mV to +800 mV and an oxidation peak was measured with a potentiostat manufactured by Hokuto Denko. The potential was then changed from +800 mV to −200 mV, and a reduction peak was measured. The presence of a large peak at about 200 mV in the CV curve indicates that the polyaniline film has not been completely oxidized, and a complete absence of the peak indicates that the polyaniline film has been oxidized.

(2) Measurement of Antirust Effect of Antirust Treated Steel Sheet

(2-1) A corrosion potential of a novel steel sheet and a steel sheet after corrosion was measured in the following manner with respect to the antirust treated steel sheet obtained in corrosion potential measurement examples.

Evaluation method: low-potential polarization measurement method.

(1) Natural potential of each sample was measured.

(2) An electric potential was applied from the natural potential in a negative side (less noble side) and a cathode polarization curve was measured.

(3) The electric potential was then returned to the natural potential, a potential was applied in a positive side (noble side), and an anode polarization curve was measured.

(4) A corrosion potential and corrosion current were found from the intersection point of tangent lines of the anode and cathode polarization curves.

(5) Same measurements were also implemented in 1 day after immersing in salt water, and the difference with corrosion potential immediately after immersing was found.

(2-2) Evaluation of Adhesive Force

Measurement method:

Evaluation: the adhesive forces were classified in three ranges: excellent, good, and poor.

(2-3) Measurement of Polarization Resistance Value

A polarization resistance value was measured by a current interactor method with respect to the antirust treated steel sheet obtained in each example.

Device: underfilm corrosion tester HL201, manufactured by Hokuto Denko.

Corrosion conditions: the antirust treated steel sheet was immersed in a 3% aqueous solution of NaCl as a corrosive liquid.

Corrosion time: after 1 h of immersion, after 240 h of immersion.

Evaluation: a ratio of [(polarization resistance value after 240 h of immersion)/(polarization resistance value after 1 h of immersion)], which is a polarization resistance value ratio, was found. When this value is high, it indicates that the corrosion advance is impeded.

### Reference Example 1

A polyaniline in an EB state that had a weight-average molecular weight (M_{W}) of 54,600 and was obtained by the usual method was heated for 1.5 h at 150° C. and oxidized in the air, and a dark violet powdered polyaniline was obtained. CV of a coated steel sheet was performed using the oxidized polyaniline. The measurement results are shown in a CV curve in FIG. 1. CV of a coated steel sheet was also performed in a similar manner by using the polyaniline in an EB state that was the starting material. The measurement results are shown in a CV curve in FIG. 2. The comparison of FIGS. 1 and 2 confirmed that the polyaniline in an EB state was converted into the polyaniline in a PE state by heating for 1.5 h at 150° C. in the air.

### Example 1

The polyaniline in a PE state obtained in the Reference Example 1 was dissolved in N-methyl-2-pyrrolidone to obtain a coating liquid with a polyaniline concentration of 3.7 wt. %. The coating liquid was coated with an applicator on a cold-rolled steel sheet that has been dried in advance in a vacuum drier for 2 h at 45° C. and the coating was heated and dried for about one and half an hour at 150° C. in the air to produce an antirust treated steel sheet with a coating film thickness of about 12 μm. The antirust effect was measured for the antirust treated steel sheet. The measurement results are shown below.

Antirust Effect of Antirust Treated Steel Sheet
Corrosion potential (Fresh): +1190 mV.
Corrosion potential (after immersing into corrosive liquid for 1 day): +1537 mV.
Adhesive force: excellent.

### Comparative Example 1

A coating liquid and an antirust treated steel sheet were obtained in the same manner as in Example 1, except that a polyaniline in an EB state was used and the drying conditions were changed to 2 h at 45° C. under vacuum. The antirust effect was measured for the antirust treated steel sheet coated with the polyaniline in an EB state. The measurement results are shown below.

Antirust Effect of Antirust Treated Steel Sheet
Corrosion potential (Fresh): −710 mV.
Corrosion potential (after immersing into corrosive liquid for 5 minutes): −710 mV.
Adhesive force: good.

### Comparative Example 2

A treated steel sheet was obtained in the same manner as in Example 1, except that no polyaniline was used as the coating liquid. The antirust effect was measured for the treated steel sheet. The measurement results are shown below.

Antirust Effect of Treated Steel Sheet

Corrosion potential (Fresh): −460 mV.

### Example 2

A powdered polyaniline in a PE state was obtained in the same manner as in Reference Example 1, except that the oxidation conditions were changed to heating for 2 h at 170° C. in the normal air. CV of the coated steel sheet was performed using the polyaniline in a PE state. A curve identical to that of the coated steel sheet of Reference Example 1 was obtained. An antirust treated steel sheet was obtained in the same manner as in Comparative Example 1, except that the PE polyaniline was used The antirust effect was measured for the antirust treated steel sheet. The results obtained were identical to those of Example 1.

### Example 3

The powdered polyaniline in a PE state obtained in Example 2 was added to an acrylic paint (Dainippon Inks And Chemicals Co., Ltd.; main component: Acridic WFJ373, curing agent: DN-980) of a two-liquid, normal temperature drying type at a ratio of 2 wt. % based on the resin component, and the components were stirred for 10 min with a homogenizer to obtain a coating liquid. The coating liquid was coated on a steel sheet in the same manner as in Example 2 and dried at normal temperature to obtain an antirust treated steel sheet with a coating film thickness of about 12 μm. A polarization resistance value was measured for the antirust treated steel sheet and the antirust effect was evaluated. The result obtained is shown below.

Polarization Resistance Value Measurement Result

Ratio of polarization resistance value: 1.23.

### Comparative Example 3

An antirust treated steel sheet with a coating film thickness of about 12 μm was obtained in the same manner as in Example 3, except that a polyaniline in an EB state was used as a starting material instead of the powdered polyaniline in a PE state obtained in Example 2. A polarization resistance value was measured for the antirust treated steel sheet and the antirust effect was evaluated. The result obtained is shown below.

Polarization Resistance Value Measurement Result

Ratio of polarization resistance value: 1.18.

The comparison of Examples 1 and 2 with Comparative Example 1 conducted based on the results obtained demonstrates that an antirust treated steel sheet coated with a polyaniline in a PE state greatly increases an antirust effect and an adhesion force between the metal base material and the coating film compared to the conventional antirust treated steel sheet coated with a polyaniline in an EB state. Further, the comparison of Example 3 with Comparative Example 3 shows that the antirust effect is improved even when the polyaniline is added merely in 2 wt. % based on a resin component.

1. A metal base material comprising a surface coated with a coating film having a corrosion inhibition effect wherein said coating film contains a polyaniline in the pernigraniline state.

2. The metal base material according to claim 1, wherein the metal base material is one from among an iron sheet, a zinc-plated steel sheet, an aluminum-plated steel sheet, a magnesium-plated steel sheet, an aluminum sheet, and a magnesium sheet.

3. The metal base material according to claim 1, wherein a metal base material surface is passivated with a polyaniline.

4. The metal base material according to claim 1, wherein said coating film containing a polyaniline in the pernigraniline state is formed on the metal base material surface by applying a coating liquid containing a polyaniline in the pernigraniline state to the metal base material surface.

5. The metal base material according to claim 4, wherein
the coating liquid contains at least one resin from among a thermoplastic resin, a thermosetting resin, a resin curable at normal temperature, and a synthetic rubber, and
a ratio of the polyaniline in the pernigraniline state to the resin is equal to or higher than 0.2 wt. %.

6. The metal base material according to claim 5, wherein
the ratio of the polyaniline in the pernigraniline state to the resin is equal to or higher than 1 wt. %.

7. The metal base material according to claim 5, wherein the resin contains at least one from among an acrylic resin, an epoxy resin, an epoxy-phenolic resin, an unsaturated polyester, a polyurethane resin, a block urethane resin, a two-component polyurethane resin, a phenolic resin, an alkyd resin, an epoxy alkyd resin, a polyimide, and a silicone resin.

8. The metal base material according to claim 1, wherein said coating film containing a polyaniline in the pernigraniline state is formed on the metal base material surface by applying a coating liquid containing a polyaniline in a partially oxidized state on the metal base material surface and oxidizing the polyaniline in the partially oxidized state at a temperature equal to or higher than 150° C. and lower than 200° C. in the presence of an oxidizing agent.

9. The metal base material according to claim 8, wherein the coating film containing a polyaniline in the pernigraniline state is formed on the metal base material surface by oxidizing the polyaniline in a partially oxidized state at a temperature equal to or higher than 170° C. and lower than 200° C. in the presence of an oxidizing agent.

10. The metal base material according to claim 8, wherein a weight-average molecular weight (M_{W}) of the polyaniline in the pernigraniline state is equal to or higher than 10,000.

11. The metal base material according to claim 8, wherein the weight-average molecular weight (M_{W}) of the polyaniline in the pernigraniline state is 20,000 to 120,000.

12. The metal base material according to claim 8, wherein the weight-average molecular weight (M_{W}) of the polyaniline in the pernigraniline state is 40,000 to 100,000.

13. A method for treating a metal base material surface for achieving a corrosion inhibition effect, comprising a process of forming a coating film containing a polyaniline in the pernigraniline state on the metal base material surface.

14. The method according to claim 13, wherein the polyaniline is in the pernigraniline state before the coating film is formed.
